(19) United States
(12) Patent Application Publication
(10) Pub. No.: US 2023/0251036 A1
(43) Pub. Date: Aug. 10, 2023

(54) METHOD FOR CONTROLLING HOT METAL TEMPERATURE, OPERATION GUIDANCE METHOD, METHOD FOR OPERATING BLAST FURNACE, METHOD FOR PRODUCING HOT METAL, DEVICE FOR CONTROLLING HOT METAL TEMPERATURE, AND OPERATION GUIDANCE DEVICE

(71) Applicant: JFE STEEL CORPORATION, Tokyo (JP)

(72) Inventors: Yoshinari HASHIMOTO, Tokyo (JP); Shunpei SHIGENO, Tokyo (JP); Ryosuke MASUDA, Tokyo (JP); Koki UCHIDA, Tokyo (JP)

(73) Assignee: JFE STEEL CORPORATION, Tokyo (JP)

(21) Appl. No.: 18/010,985

(22) PCT Filed: Jun. 14, 2021
(86) PCT No.: PCT/JP2021/022519

§ 371 Date: Dec. 16, 2022

(30) Foreign Application Priority Data
Jul. 6, 2020 (JP) 2020-116369

(51) Int. Cl. F27B 1/26; F27D 19/00; C21B 7/24

(52) U.S. Cl. CPC F27B 1/26; F27D 19/00; C21B 7/24; F27D 2019/004

(57) ABSTRACT

A method for controlling a hot metal temperature, includes: a first control loop for calculating a target value of pulverized coal ratio such that a hot metal temperature, predicted by a physical model that is able to calculate conditions inside a blast furnace, falls within a preset target range; and a second control loop for calculating pulverized coal flow rate manipulation quantity to compensate for a deviation between the pulverized coal ratio target value and a current pulverized coal ratio actual value.

### FIELD

The present invention relates to a method for controlling a hot metal temperature, an operation guidance method, a method for operating a blast furnace, a method for producing a hot metal, a device for controlling a hot metal temperature, and an operation guidance device.

### BACKGROUND

In a blast furnace process in the iron industry, a hot metal temperature is an important management indicator. The hot metal temperature is controlled mainly by manipulating a pulverized coal ratio (PCR), which indicates a pulverized coal flow rate per ton of hot metal. Blast furnace operations in recent years have been performed under conditions of a low coke ratio and a high pulverized coal ratio in order to rationalize raw material and fuel costs, and thus a furnace condition becomes easily unstable. Accordingly, there is a great need for reducing variations in hot metal temperatures.

Furthermore, because operations are performed in a state in which the inside of a furnace is filled with solids, the blast furnace process has the characteristics that the heat capacity of the entire process is larger and a time constant for a response to manipulation (operation action) is larger. Furthermore, there is a waste time on the order of several hours before raw material charged from a top of the blast furnace (furnace top portion) descends to a bottom of the blast furnace (furnace bottom). Therefore, in order to control a hot metal temperature, optimization of manipulation quantity of a manipulated variable is essential based on future furnace heat prediction.

Against this background, a furnace heat prediction method using a physical model is proposed in Patent Document 1. In the furnace heat prediction method described in Patent Document 1, so as to match composition of a current furnace top gas, a gas reduction rate parameter included in a physical model is adjusted and a furnace heat is predicted using the physical model after the parameter adjustment.

### CITATION LIST

### Patent Literature

[Patent Document 1] Japanese Patent Application Laid-open No. H11-335710

### SUMMARY

### Technical Problem

However, the conventional hot metal temperature control method has the problem that control performance is reduced when a change in raw material descending speed (unloading) occurs due to changes in air permeability. A direct manipulated variable by an operator is the pulverized coal flow rate [kg/min] blown in through a tuyere. However, even if the pulverized coal flow rate is constant, change in the production rate of hot metal (hereinafter referred to as “hot metal making rate”) “t/min” will cause a pulverized coal ratio (PCR), which is calculated by the ratio of the pulverized coal flow rate to the hot metal making rate, to change, resulting in changes in hot metal temperature.

The hot metal making rate is generally proportional to an oxygen flow rate supplied to the furnace, but even if this oxygen flow rate is constant, a bulk density of the raw material temporarily decreases and unloading becomes slower when the air permeability inside the furnace deteriorates. In such a case, with the conventional hot metal temperature control method using a physical model, there has been a problem in that the control accuracy has been reduced.

The present invention has been made in view of the above, and an object thereof is to provide a method for controlling a hot metal temperature that is hardly affected by changes in unloading due to changes in air permeability, an operation guidance method, a method for operating a blast furnace, a method for producing a hot metal, a device for controlling a hot metal temperature, and an operation guidance device.

### Solution to Problem

To solve the problem and achieve the object, a method for controlling a hot metal temperature according to the present invention includes executing: a first control loop for calculating a target value of pulverized coal ratio such that a hot metal temperature, predicted by a physical model that is able to calculate conditions inside a blast furnace, falls within a preset target range; and a second control loop for calculating pulverized coal flow rate manipulation quantity to compensate for a deviation between the pulverized coal ratio target value and a current pulverized coal ratio actual value.

Moreover, in the method for controlling the hot metal temperature according to the present invention, the first control loop includes: a free response calculation step of calculating a free response indicating a response of a hot metal temperature when manipulation quantities of all manipulated variables among a plurality of predetermined manipulated variables are constant for a predetermined period, by using the physical model; a step response calculation step of calculating a step response indicating a response of a hot metal temperature when the pulverized coal ratio manipulation quantity among the plurality of manipulated variables is made to change stepwise by a unit amount, by using the physical model; a PCR manipulation quantity calculation step of calculating a pulverized coal ratio manipulation quantity to make the hot metal temperature fall within the target range, based on the free response and the step response; and a PCR target value calculation step of calculating a target value of the pulverized coal ratio, by adding the pulverized coal ratio manipulation quantity to a target value of current pulverized coal ratio.

Moreover, in the method for controlling the hot metal temperature according to the present invention, the second control loop includes: a pulverized coal ratio deviation calculation step of calculating pulverized coal ratio deviation from the pulverized coal ratio target value calculated in the first control loop, the pulverized coal ratio actual value, and a hot metal making rate actual value calculated in advance; and a PCI manipulation quantity calculation step of calculating the pulverized coal flow rate manipulation quantity from the pulverized coal ratio deviation and the hot metal making rate actual value.

Moreover, in the method for controlling the hot metal temperature according to the present invention, at the PCR manipulation quantity calculation step, the pulverized coal ratio manipulation quantity is calculated such that when manipulation quantities of all manipulated variables among the plurality of manipulated variables are constant for a predetermined period, a predicted value of the hot metal temperature, after the predetermined period has elapsed, is included in upper and lower limits of a preset hot metal temperature.

Moreover, in the method for controlling the hot metal temperature according to the present invention, the hot metal making rate actual value is calculated based on a raw material fed into a blast furnace from a point in time to calculate a manipulation quantity to a predetermined time before the point in time to calculate the manipulation quantity, or hot air blown into through a tuyere of the blast furnace and a gas emitted from a furnace top, from the point in time to calculate the manipulation quantity to the predetermined time before the point in time to calculate the manipulation quantity.

Moreover, an operation guidance method according to the present invention includes a step of supporting operation of a blast furnace by presenting pulverized coal flow rate manipulation quantity calculated by the method for controlling the hot metal temperature according to the present invention.

Moreover, a method for operating a blast furnace according to the present invention includes a step of controlling a blast furnace in accordance with pulverized coal flow rate manipulation quantity calculated by the method for controlling the hot metal temperature according to the present invention.

Moreover, a method for producing a hot metal according to the present invention includes a step of controlling a blast furnace in accordance with pulverized coal flow rate manipulation quantity calculated by the method for controlling the hot metal temperature according to the present invention, and producing the hot metal.

Moreover, a device for controlling a hot metal temperature according to the present invention includes a means for executing: a first control loop for calculating a target value of pulverized coal ratio such that a hot metal temperature, predicted by a physical model that is able to calculate conditions inside a blast furnace, falls within a preset target range; and a second control loop for calculating pulverized coal flow rate manipulation quantity to compensate for a deviation between the pulverized coal ratio target value and a current pulverized coal ratio actual value.

Moreover, an operation guidance device according to the present invention includes a means for supporting operation of a blast furnace by presenting pulverized coal flow rate manipulation quantity calculated by the device for controlling the hot metal temperature according to the present invention.

### Advantageous Effects of Invention

With the method for controlling the hot metal temperature, the operation guidance method, the method for operating the blast furnace, the method for producing the hot metal, the device for controlling the hot metal temperature, and the operation guidance device according to the present invention, the hot metal temperature can be controlled without being affected by changes in unloading due to changes in air permeability. Thus, highly efficient and stable operation of the blast furnace can be achieved.

### BRIEF DESCRIPTION OF DRAWINGS

FIG. 1 is a block diagram illustrating an approximate configuration of a device for controlling a hot metal temperature according to an embodiment of the present invention.

FIG. 2 is a diagram illustrating an example of input variables and output variables of a physical model used in the method for controlling the hot metal temperature according to the embodiment of the present invention.

FIG. 3 is a diagram illustrating a structure of a control loop in the method for controlling the hot metal temperature according to the embodiment of the present invention.

FIG. 4 is a diagram illustrating prediction results of the hot metal temperature using the physical model in the method for controlling the hot metal temperature.

FIG. 5 is a diagram illustrating step responses of a hot metal temperature to change in pulverized coal ratio in the method for controlling the hot metal temperature according to the embodiment of the present invention.

FIG. 6 is a diagram indicating results of applying the method for controlling the hot metal temperature according to the embodiment of the present invention to an actual operation of the blast furnace. Specifically, FIG. 6 is a diagram indicating a deviation of an actual value to a target value for the hot metal temperature, a pulverized coal ratio manipulation quantity by the present control and the operator, transition in a target value and an actual value of the pulverized coal ratio, and pulverized coal flow rate manipulation quantity by the present control and the operator.

### DESCRIPTION OF EMBODIMENTS

A method for controlling a hot metal temperature, an operation guidance method, a method for operating a blast furnace operation, a method for producing a hot metal, a device for controlling a hot metal temperature, and an operation guidance device according to an embodiment of the present invention will be described with reference to the drawings.

### Configuration of Device for Controlling Hot Metal Temperature

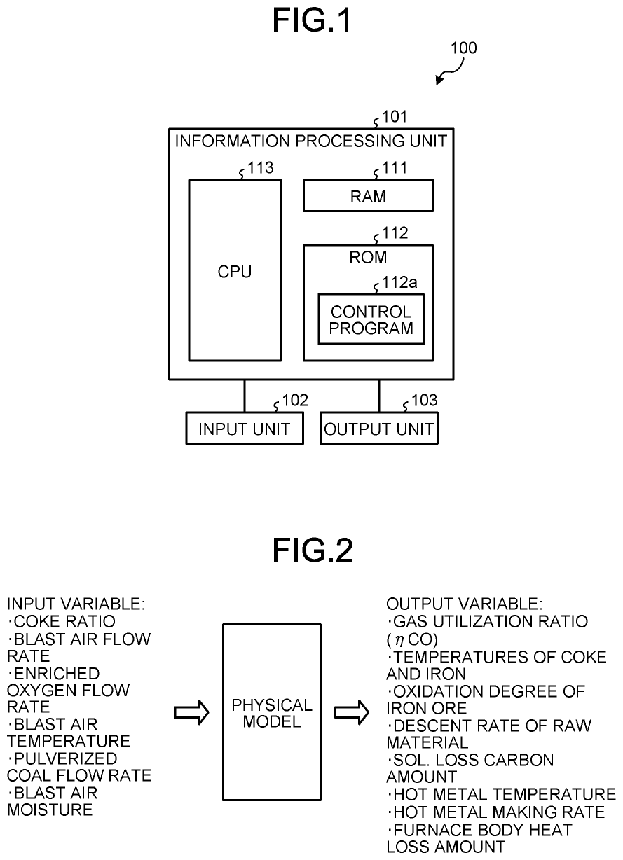

First, a configuration of a device for controlling a hot metal temperature (hereinafter referred to as “control device”) according to the embodiment of the present invention will be described with reference to FIG. 1. A control device 100 includes an information processing unit 101, an input unit 102, and an output unit 103.

The information processing unit 101 is configured by a general-purpose device such as a personal computer or a workstation, and includes a RAM 111, a ROM 112, and a CPU 113. The RAM 111 temporarily stores processing programs and processing data related to processing executed by the CPU 113 and functions as a working area for the CPU 113.

The ROM 112 stores a control program 112a that executes the hot metal temperature control method according to the embodiment of the present invention, and processing programs and processing data that control the entire operation of the information processing unit 101.

The CPU 113 controls the entire operation of the information processing unit 101 according to the control program 112a and the processing program stored in the ROM 112. The CPU 113 functions as a free response calculation means for performing a free response calculation step, a step response calculation means for performing a step response calculation step, and a PCR manipulation quantity calculation means for performing a PCR manipulation quantity calculation step, in the hot metal temperature control method described below. The CPU 113 also functions as a PCR target value calculation means for performing a PCR target value calculation step, a pulverized coal ratio deviation calculation means for performing a pulverized coal ratio deviation calculation step, a PCI manipulation quantity calculation means for performing a PCI manipulation quantity calculation step, and a PCI set value calculation means for performing a PCI set value calculation step.

The input unit 102 includes devices such as a keyboard, a mouse pointer, and a numeric keypad, and is manipulated when various information is input to the information processing unit 101. The output unit 103 includes a display device, a printing device, and the like, and outputs various processing information of the information processing unit 101.

### Physical Model Configuration

Next, a physical model used in the method for controlling the hot metal temperature according to the embodiment of the present invention will be described. The physical model used in the present invention includes a set of partial differential equations that take into account several physical phenomena such as iron ore reduction, heat exchange between iron ore and coke, and melting of iron ore, similarly to a method described in Reference 1 (Michiharu Hatano, et al.: “Investigation of Blow-in Operation through the Blast Furnace Dynamic Model”, Iron and Steel, Vol. 68, p. 2369). The physical model used in the present invention is a physical model capable of calculating variables (output variables) that indicate conditions inside the blast furnace in a non-steady state (hereinafter referred to as “dynamic model”).

As illustrated in FIG. 2, the main time change boundary conditions (input variables, blast furnace manipulated variables (also called operating factors)) that are given to this dynamic model are as follows.
(1) Coke ratio at the furnace top (CR) [kg/t]: Coke input per ton of hot metal
(2) Blast air flow rate (BV) [Nm³/min]: Flow rate of air blown into the blast furnace
(3) Enriched oxygen flow rate (BVO) [Nm³/min]: Flow rate of enriched oxygen blown into the blast furnace
(4) Blast air temperature (BT) [° C.]: Temperature of air blown into the blast furnace
(5) Pulverized coal flow rate (pulverized coal blowing rate, PCI) [kg/min]: Weight of pulverized coal used for one ton of hot metal production
(6) Blast air moisture (BM) [g/Nm³]: moisture of air blown into the blast furnace

In addition, the main output variables formed by the dynamic model are as follows.
(1) Gas utilization ratio in the furnace (ηCO): CO₂/(CO+CO₂)
(2) Temperature of coke and iron
(3) Oxidation degree of iron ore
(4) Descent rate of raw material
(5) Solution loss carbon amount (sol. loss carbon amount)
(6) Hot metal temperature
(7) Hot metal making rate (hot metal production speed)
(8) Furnace body heat loss amount: Amount of heat deprived by cooling water when the furnace body is cooled by cooling water

In the present invention, a time step (time interval) for calculating output variables was 30 minutes. However, the time step is variable according to purposes and is not limited to the value of the present embodiment. This dynamic model is used to calculate output variables, including hot metal temperatures and hot metal making rates, which change from time to time.

### Control Loop

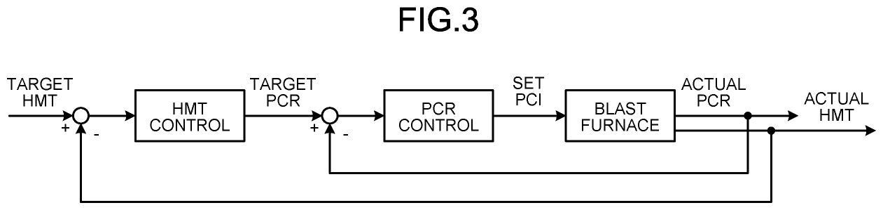

Next, a control loop to be executed in the method for controlling the hot metal temperature according to the present embodiment is described. In the method for controlling the hot metal temperature according to the present embodiment, as illustrated in FIG. 3, a dual control loop including a first control loop (HMT control loop) and a second control loop (PCR control loop) is executed. In the first control loop, a target value of the pulverized coal ratio (target PCR) is calculated such that a hot metal temperature predicted by a dynamic model capable of calculating conditions inside the blast furnace falls within a preset target range (target HMT). In the second control loop, pulverized coal flow rate manipulation quantity is calculated to compensate for a deviation between a pulverized coal ratio target value (target PCR) and a current pulverized coal ratio actual value (actual PCR).

### Method for Controlling Hot Metal Temperature

Next, the method for controlling the hot metal temperature using the above-described dynamic model according to the present embodiment will be described. In the method for controlling the hot metal temperature according to the present embodiment, the free response calculation step, the step response calculation step, the PCR manipulation quantity calculation step, the PCR target value calculation step, the pulverized coal ratio deviation calculation step, the PCI manipulation quantity calculation step, and the PCI set value calculation step are performed in this order. The above-described dynamic model can be illustrated, for example, as in Equations (1) and (2) below.

x(t+1)=f(x(t),u(t)) (1)

y(t)=C(x(t)) (2)

Here, in the above-described Equations (1) and (2), x(t) is a state variable calculated in the dynamic model (temperatures of coke and iron, oxidation degree of iron ore, descent rate of raw material, and the like), and y(t) is a hot metal temperature that is a control variable (Hot Metal Temperature: HMT). Moreover, C is a matrix or a function for extracting control variables from the state variables calculated within the dynamic model.

In addition, u(t) in the above-described Equation (1) is blast air flow rate, enriched oxygen flow rate, pulverized coal flow rate, blast air moisture, blast air temperature, and coke ratio, which are input variables of the dynamic model. This u(t) can be expressed as “u(t)=(BV(t), BVO(t), PCI(t), BM(t), BT(t), CR(t))”.

(Free Response Calculation Step)

First, a predictive calculation of future hot metal temperature HMT is performed, assuming that the current manipulation quantities of all manipulated variables are held constant. Specifically, at this step, the above-described dynamic model is used to calculate a response of the hot metal temperature HMT when the manipulation quantities of all manipulated variables among a plurality of predetermined manipulated variables (input variables) are constant for a predetermined period. At this step, specifically, the current time step is placed at t=0, and Equations (3) and (4) below are used to calculate a future hot metal temperature HMT. If there is an estimation error between the current hot metal temperature estimated by the dynamic model and the actual hot metal temperature at the current time, the following process may be used if necessary. Specifically, a correction may be implemented to eliminate a bias error from the actual value by adding the estimation error to a calculated value by the dynamic model.

x(t+1)=f(x(t),u(0)) (3)

y₀(t)=C(x(0) (4)

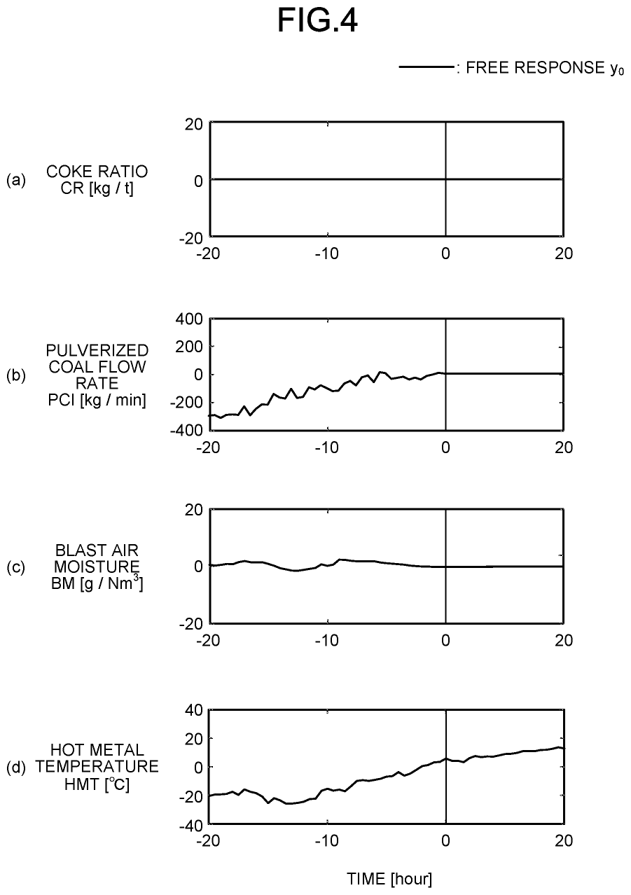

The response y₀ of the control variable (in this case, hot metal temperature) thus obtained is referred to as “free response” in the present embodiment. FIG. 4 indicates an example of the results of predicting some of the manipulated variables (input variables) (coke ratio CR, pulverized coal flow rate PCI, and blast air moisture BM) and hot metal temperature HMT. Calculated values of the hot metal temperature HMT in the past sections are calculated using actual manipulated variables in the past.

(Step Response Calculation Step)

At this step, the above-described dynamic model is used to calculate a step response indicating a response of the hot metal temperature HMT when the pulverized coal ratio manipulation quantity among the plurality of manipulated variables (input variables) is made to change stepwise by a unit amount.

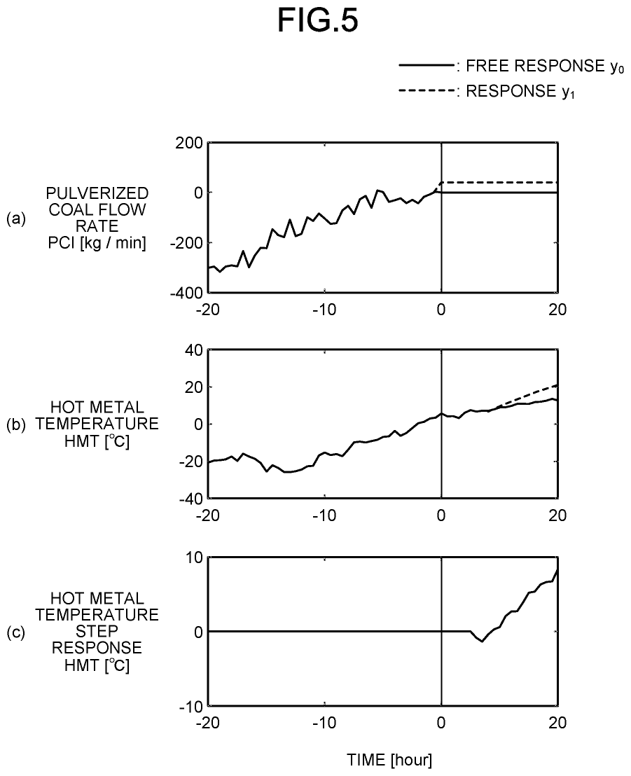

A free response Y₀ of the hot metal temperature HMT obtained in the free response calculation step is indicated by a solid line in FIG. 5(b). At this step, as indicated by a dashed line in FIG. 5(a), a response of the hot metal temperature HMT when the pulverized coal ratio PCR is increased by 10 kg/t at time 0 is calculated with the other manipulated variables maintained, using Equations (5) and (6) below.

x(t+1)=f(x(t),u(0)+Δu₁) (5)

y₁(t)=C(x(t) (6)

An amount of increase in the pulverized coal flow rate PCI is obtained by multiplying the increase in the pulverized coal ratio PCR by the current hot metal making rate. In the above-described Equation (5), the manipulation to increase the pulverized coal flow rate PCI is placed as Δu₁. The response y₁ of the hot metal temperature HMT obtained at this step is indicated by the dashed line in FIG. 5(b).

A step response of the hot metal temperature HMT to changes in pulverized coal ratio PCR is then calculated by taking a difference between the response y₁ of the hot metal temperature HMT (see the dashed line in FIG. 5(b)) and the free response y₀ of the hot metal temperature HMT (see the solid line in FIG. 5(b)), obtained as described above. Here, the output is divided by 10 to obtain a step response to the unit amount.

(PCR Manipulation Quantity Calculation Step)

Subsequently, a manipulation width of the pulverized coal ratio PCR is determined such that a future hot metal temperature HMT falls within a target range (target HMT). In other words, at this step, a pulverized coal ratio manipulation quantity ΔPCR to make the hot metal temperature HMT fall within the target range is calculated based on the free response obtained in the free response calculation step and the step response obtained in the step response calculation step.

At this step, the pulverized coal ratio manipulation quantity ΔPCR is calculated as indicated in Equation (7) below in order to make the hot metal temperature HMT fall within the target range while avoiding excessive operation actions. In other words, the pulverized coal ratio manipulation quantity ΔPCR is calculated such that the predicted value of the hot metal temperature HMT after a predetermined period of time has elapsed is included in upper and lower limits of a preset hot metal temperature HMT, when manipulation quantities of all manipulated variables among the plurality of manipulated variables (input variables) are constant for a predetermined period. Since the time required from the time when iron ore is fed into the furnace to the time when discharged out of the furnace is about 8 hours, a predicted interval for the hot metal temperature HMT in Equation (7) below is set to 10 hours. In addition, a control interval is set to one step to simplify a control logic.

ΔPCR=−(max(Tₚᵣₑ¹⁰−T_{U},0)+min(Tₚᵣₑ¹⁰−T_{L},0))/S_{PCR}¹⁰ (7)

In the above-described Equation (7), T¹⁰ₚᵣₑ is the predicted value of the hot metal temperature HMT after 10 hours, T_{U} is an upper limit of the hot metal temperature HMT, T_{L} is a lower limit of the hot metal temperature HMT, and S¹⁰_{PCR} is the step response of the hot metal temperature HMT to changes in pulverized coal ratio PCR after 10 hours. Providing such a control rule reduces an operator's workload associated with the manipulation quantity change because the pulverized coal ratio manipulation quantity ΔPCR is zero as long as T¹⁰ₚᵣₑ falls within the target range.

(PCR Target Value Calculation Step)

Then, as indicated in Equation (8) below, by adding the pulverized coal ratio manipulation quantity ΔPCR obtained in the PCR manipulation quantity calculation step to the target value PCR⁰_{ref} of the current pulverized coal ratio managed by the operator, a target value PCR_{ref} of the pulverized coal ratio is calculated. The above description corresponds to the first control loop (HMT control loop) in FIG. 3.

PCR_{ref}=PCR_{ref}⁰+ΔPCR (8)

(Pulverized Coal Ratio Deviation Calculation Step)

At this step, deviation (pulverized coal ratio deviation) between the pulverized coal ratio actual value PCR_{ref} obtained in the PCR target value calculation step and the actual value of the current pulverized coal ratio is calculated.

Here, in order to calculate the current pulverized coal ratio actual value (actual PCR), obtaining a ratio of the pulverized coal flow rate actual value to the hot metal making rate actual value is required. Examples of methods of obtaining the hot metal making rate include a method of obtaining by oxygen balance, and a method of obtaining by pig iron conversion quantity of iron oxide contained in a raw material layer (charge) fed into the blast furnace. For example, when obtaining a hot metal making rate from the oxygen balance, it is possible to obtain hot metal making rate by obtaining a difference between an amount of oxygen contained in hot air blown into through the tuyere of the blast furnace and an amount of oxygen contained in a gas emitted from the furnace top.

In the present embodiment, based on pig iron conversion quantity of iron oxide contained in the raw material layer (charge) fed into the blast furnace, a current pulverized coal ratio actual value is obtained from a frequency of feeding raw material in nearest eight charges. In other words, where N is a charge number currently being charged, A is the number of raw material layers present in the furnace, Time [i] is a charging start time of the i-th charge, and Pig [i] is pig iron conversion quantity, the current hot metal making rate Prod (t) can be calculated by Equation (9) below.

$$Prod ( t ) = \frac{{{\sum }_{i = N - A - 7}}^{N - A} Pig [ i ]}{Time [ N ] - Time [ N - 7 ]} \qquad ( 9 )$$

Here, the pig iron conversion quantity Pig in the above-described Equation (9) indicates, more specifically, a converted weight of a portion that turns into pig iron to a weight of raw material fed into the blast furnace. In the above-described Equation (9), the reason why raw material layers are traced back to the past only by the A number of layers is to obtain the hot metal making rate based on a pig iron quantity contained in a raw material layer at the height of the tuyere. As indicated in the above-described Equation (9), by dividing the pig iron quantity fed into the blast furnace by the time required for the charging of the nearest eight charges of raw material, it is possible to obtain the amount of pig iron fed during the relevant time, that is, the hot metal making rate. Since changes in hot metal making rate are large when calculated based on actual values over a short period of time, it is desirable to smooth the pig iron making rate over a period of time ranging from one to three hours. The average time for eight charges here corresponds to approximately two hours in a normal operation.

Subsequently, deviation δPCR between the pulverized coal ratio target value PCR_{ref} and the current pulverized coal ratio actual value is calculated using Equation (10) below.

$$δ P C R = \frac{PCI ( t )}{P r o d ( t )} - P C {R}_{r e f} \qquad ( 10 )$$

(PCI Manipulation Quantity Calculation Step)

At this step, when a pulverized coal ratio deviation δPCR occurs, pulverized coal flow rate manipulation quantity ΔPCI to compensate for the deviation δPCR is calculated using Equation (11) below.

ΔPCI=−δPCR·Prod(t) (11)

(PCI Set Value Calculation Step)

At this step, by adding the pulverized coal flow rate manipulation quantity ΔPCI obtained in the PCI manipulation quantity calculation step to a set value of the current pulverized coal flow rate, a set value (setting PCI) of the pulverized coal flow rate is calculated. The above description corresponds to the second control loop (PCR control loop) in FIG. 3. The foregoing processing enables appropriate manipulation of pulverized coal flow rate PCI to control the hot metal temperature HMT. Even if any changes in the unloading occur due to changes in air permeability, the PCR control loop constituted of Equations (9) through (11) above can suppress changes in pulverized coal ratio PCR, thereby reducing variations in the hot metal temperature HMT.

### EXAMPLE

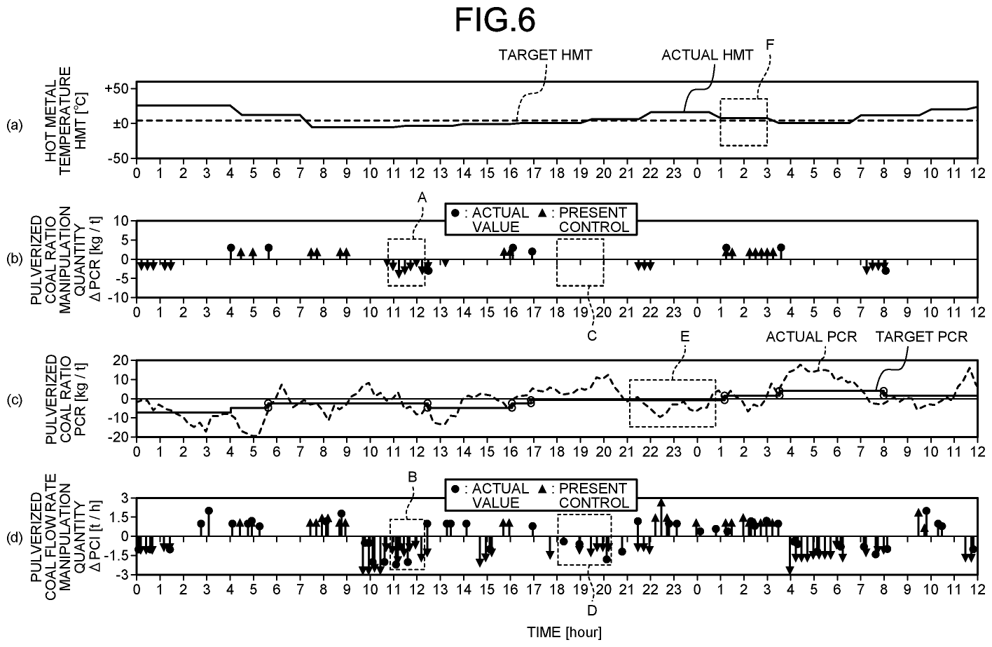

FIG. 6 is an example of results of applying the method for controlling the hot metal temperature according to the present embodiment to an actual operation of the blast furnace. FIG. 6(a) indicates a deviation of an actual value to a target value for the hot metal temperature. In FIG. 6(a), a solid line indicates an actual value of the hot metal temperature (actual HMT) and a dashed line indicates the target value of the hot metal temperature (target HMT). FIG. 6(b) indicates results of comparison between the pulverized coal ratio manipulation quantity ΔPCR by the present control and the actual manipulation quantity of the pulverized coal ratio manipulated by the operator. In FIG. 6(b), triangle marks indicate manipulation by the present control, and circles indicate manipulation by the operator.

FIG. 6(c) indicates results of comparison in transition between the target value and the actual value of the pulverized coal ratio. In FIG. 6(c), a dashed line indicates a pulverized coal ratio actual value (actual PCR) and a solid line indicates a target pulverized coal ratio target value (target PCR). The vertical axis of FIG. 6(c) indicates a deviation of the pulverized coal ratio from a typical value. As the “typical value of pulverized coal ratio”, the average value of pulverized coal ratio during normal operation of the blast furnace, or the like can be used.

FIG. 6(d) indicates results of comparison between the pulverized coal ratio manipulation quantity ΔPCI by the present control, and the actual pulverized coal flow rate manipulation quantity manipulated by the operator as in the past. In FIG. 6(d), triangle marks indicate manipulation by the present control, and circles indicate manipulation by the operator. It should be noted that the “present control” in FIGS. 6(b) and 6(d) is not complete automated control, but control as a result of testing performed in a form in which the operator is given guidance.

As indicated in FIG. 6(a), the operator generally performs manipulation following the guidance, and is able to keep the hot metal temperature near the target value. For example, as indicated in part A of FIG. 6(b) and part B of FIG. 6(d), a lowering action of the pulverized coal flow rate is output along with the pulverized coal ratio from 11:00 to 12:00. As a result of performing by the operator manipulation according to the present control, the hot metal temperature is kept near the target value.

As indicated in part C of FIG. 6(b) and part D of FIG. 6(d), manipulation of the pulverized coal flow rate manipulation quantity ΔPCI is output during a period from 18:00 to 20:00, even though the pulverized coal ratio manipulation quantity ΔPCR is zero. As a result, as illustrated in part E of FIG. 6(c), the pulverized coal ratio PCR is kept near the target value, and as illustrated in part F of FIG. 6(a), changes in hot metal temperature are suppressed. The foregoing demonstrates the usefulness of the hot metal temperature control method according to the present embodiment in actual operations.

### Operation Guidance Method

The method for controlling the hot metal temperature according to the present embodiment can also be applied to the operation guidance method. In this case, the following steps are performed in addition to the free response calculation step, the step response calculation step, the PCR manipulation quantity calculation step, the PCR target value calculation step, the pulverized coal ratio deviation calculation step, and the PCI manipulation quantity calculation step in the method for controlling the hot metal temperature described above. Specifically, the step of supporting the operation of the blast furnace by representing the pulverized coal flow rate manipulation quantity ΔPCI calculated in the PCI manipulation quantity calculation step to the operator, for example, via the output unit 103, is performed.

### Method for Operating Blast Furnace

The method for controlling the hot metal temperature according to the present embodiment can also be applied to the method for controlling the blast furnace. In this case, the following steps are performed in addition to the free response calculation step, the step response calculation step, the PCR manipulation quantity calculation step, the PCR target value calculation step, the pulverized coal ratio deviation calculation step, and the PCI manipulation quantity calculation step in the method for controlling the hot metal temperature described above. Specifically, the step of controlling the blast furnace is performed according to the pulverized coal flow rate manipulation quantity ΔPCI calculated in the PCI manipulation quantity calculation step.

### Method for Producing Hot Metal

The method for controlling the hot metal temperature according to the present embodiment can also be applied to the method for producing the hot metal. In this case, the following steps are performed in addition to the free response calculation step, the step response calculation step, the PCR manipulation quantity calculation step, the PCR target value calculation step, the pulverized coal ratio deviation calculation step, and the PCI manipulation quantity calculation step in the method for controlling the hot metal temperature described above. Specifically, the step of controlling the blast furnace and producing hot metal according to the pulverized coal flow rate manipulation quantity ΔPCI calculated in the PCI manipulation quantity calculation step.

According to the method for controlling the hot metal temperature, the operation guidance method, the method for operating the blast furnace, the method for producing the hot metal, the device for controlling the hot metal temperature, and the operation guidance device according to the present invention as described above, the hot metal temperature can be controlled without being affected by changes in unloading due to changes in air permeability. Thus, highly efficient and stable operation of the blast furnace can be achieved.

In the conventional method for controlling the hot metal temperature, for example, pulverized coal ratio guidance is performed, and the operator only manipulates the pulverized coal flow rate according to that guidance. In contrast, the method for controlling the hot metal temperature according to the present embodiment allows a dual-structure control loop (see FIG. 3) including the HMT control loop and the PCR control loop to calculate the pulverized coal flow rate manipulation quantity, thus achieving automated control of the hot metal temperature.

In the foregoing, while the method for controlling the hot metal temperature, the operation guidance method, the method for operating the blast furnace, the method for producing the hot metal, the device for controlling the hot metal temperature, and the operation guidance device, according to the present invention have been specifically described by mode for carrying out the invention and examples, the purpose of the present invention is not limited to these descriptions and should be interpreted broadly based on the claims. Moreover, various changes, modifications, and the like based on these descriptions are also included in the purpose of the present invention.

### REFERENCE SIGNS LIST

100 Control device

101 Information processing unit

102 Input unit

103 Output unit

111 RAM

112 ROM

112a Control program

113 CPU

1-10. (canceled)

11. A method for controlling a hot metal temperature, the method comprising executing:
a first control loop for calculating a target value of pulverized coal ratio such that a hot metal temperature, predicted by a physical model that is able to calculate conditions inside a blast furnace, falls within a preset target range; and
a second control loop for calculating pulverized coal flow rate manipulation quantity to compensate for a deviation between the pulverized coal ratio target value and a current pulverized coal ratio actual value.

12. The method for controlling the hot metal temperature according to claim 11, wherein the first control loop includes:
calculating a free response indicating a response of a hot metal temperature when manipulation quantities of all manipulated variables among a plurality of predetermined manipulated variables are constant for a predetermined period, by using the physical model;
calculating a step response indicating a response of a hot metal temperature when the pulverized coal ratio manipulation quantity among the plurality of manipulated variables is made to change stepwise by a unit amount, by using the physical model;
calculating a pulverized coal ratio manipulation quantity to make the hot metal temperature fall within the target range, based on the free response and the step response; and
calculating a target value of the pulverized coal ratio, by adding the pulverized coal ratio manipulation quantity to a target value of current pulverized coal ratio.

13. The method for controlling the hot metal temperature according to claim 11, wherein the second control loop includes:
calculating pulverized coal ratio deviation from the pulverized coal ratio target value calculated in the first control loop, the pulverized coal ratio actual value, and a hot metal making rate actual value calculated in advance; and
calculating the pulverized coal flow rate manipulation quantity from the pulverized coal ratio deviation and the hot metal making rate actual value.

14. The method for controlling the hot metal temperature according to claim 12, wherein the second control loop includes:
calculating pulverized coal ratio deviation from the pulverized coal ratio target value calculated in the first control loop, the pulverized coal ratio actual value, and a hot metal making rate actual value calculated in advance; and
calculating the pulverized coal flow rate manipulation quantity from the pulverized coal ratio deviation and the hot metal making rate actual value.

15. The method for controlling the hot metal temperature according to claim 12, wherein, at the calculating the pulverized coal ratio manipulation quantity, the pulverized coal ratio manipulation quantity is calculated such that when manipulation quantities of all manipulated variables among the plurality of manipulated variables are constant for a predetermined period, a predicted value of the hot metal temperature, after the predetermined period has elapsed, is included in upper and lower limits of a preset hot metal temperature.

16. The method for controlling the hot metal temperature according to claim 13, wherein the hot metal making rate actual value is calculated based on
a raw material fed into a blast furnace from a predetermined time before a point in time to calculate a manipulation quantity to the point in time to calculate the manipulation quantity, or
hot air blown into through a tuyere of the blast furnace and a gas emitted from a furnace top, from the predetermined time before the point in time to calculate the manipulation quantity to the point in time to calculate the manipulation quantity.

17. The method for controlling the hot metal temperature according to claim 14, wherein the hot metal making rate actual value is calculated based on
a raw material fed into a blast furnace from a predetermined time before a point in time to calculate a manipulation quantity to the point in time to calculate the manipulation quantity, or
hot air blown into through a tuyere of the blast furnace and a gas emitted from a furnace top, from the predetermined time before the point in time to calculate the manipulation quantity to the point in time to calculate the manipulation quantity.

18. An operation guidance method comprising supporting operation of a blast furnace by presenting pulverized coal flow rate manipulation quantity calculated by the method for controlling the hot metal temperature according to claim 11.

19. A method for operating a blast furnace, the method comprising controlling a blast furnace in accordance with pulverized coal flow rate manipulation quantity calculated by the method for controlling the hot metal temperature according to claim 11.

20. A method for producing a hot metal, the method comprising:
controlling a blast furnace in accordance with pulverized coal flow rate manipulation quantity calculated by the method for controlling the hot metal temperature according to claim 11.

21. A device for controlling a hot metal temperature, the device comprising a processor comprising hardware, the processor being configured to execute:
a first control loop for calculating a target value of pulverized coal ratio such that a hot metal temperature, predicted by a physical model that is able to calculate conditions inside a blast furnace, falls within a preset target range; and
a second control loop for calculating pulverized coal flow rate manipulation quantity to compensate for a deviation between the pulverized coal ratio target value and a current pulverized coal ratio actual value.

22. An operation guidance device comprising a processor comprising hardware, the processor being configured to support operation of a blast furnace by presenting pulverized coal flow rate manipulation quantity calculated by the device for controlling the hot metal temperature according to claim 21.
